(19) United States
(12) Patent Application Publication
(10) Pub. No.: US 2011/0258227 A1
(43) Pub. Date: Oct. 20, 2011

(54) METHOD AND SYSTEM FOR SEARCHING DOCUMENTS

(75) Inventor: Randy W. Lacasse, Fairfax Station, VA (US)

(73) Assignee: CPA GLOBAL PATENT RESEARCH LIMITED

(21) Appl. No.: 13/151,960

(22) Filed: Jun. 2, 2011

Related U.S. Application Data
(63) Continuation-in-part of application No. 11/260,337, filed on Oct. 27, 2005.
Application No. 11/260,337 is a continuation of application No. 10/610,658, filed on Jul. 1, 2003, now abandoned.
Application No. 10/610,658 is a continuation of application No. 09/364,064, filed on Jul. 30, 1999, now Pat. No. 6,530,939.

(51) Int. Cl. G06F 17/30

(52) U.S. Cl. 707/769; 707/E17.014

(57) ABSTRACT

A method and system for searching documents is provided. The method includes creating one or more document vectors from one or more input documents. The method further includes performing a search on a document database based on the document vectors to locate one or more output documents related to one or more input documents. Thereafter, the method includes creating an interactive work-file including a list of the output documents and analysis of one or more attributes associated with the output documents. The interactive work-file can be stored and shared by a legal practitioner. The legal practitioner may share the interactive work-file with external legal practitioners and external legal examining authorities.

### RELATED APPLICATIONS

This application is a continuation in-part under 37 C.F.R. 1.53(b) and claims the benefit of U.S. patent application Ser. No. 11/260,337 filed Oct. 27, 2005, which is a continuation under 37 C.F.R. 1.53(b) of U.S. patent application Ser. No. 10/610,658 filed Jul. 1, 2003, which is a continuation under 37 C.F.R. 1.53 (b) of U.S. patent application Ser. No. 09/346,064 filed Jul. 1, 1999, now U.S. Pat. No. 6,594,662 issued Jul. 15, 2003, which claims priority from U.S. Provisional Application Ser. No. 60/091,348 filed Jul. 1, 1998, which applications are incorporated herein by reference.

This application also claims the benefit of U.S. patent application Ser. No. 12/644,709 filed Dec. 22, 2009, which is incorporated herein by reference.

### BACKGROUND OF THE INVENTION

This invention generally relates to searching electronic documents. More specifically, the invention is related to a method and system for efficiently searching electronic documents that are similar.

All intellectual property documents, including patent, trademark, and copyright application must be submitted for registration or examination before a government agency assigned to receive such application. Patent applications submitted for examination before a government patent office must meet certain requirements, including for the United States Patent Office, each invention must be deemed new, useful, and non-obvious. Similar standards are applied in patent offices of most, if not all, foreign patent offices. To properly prepare a patent application for examination, it is useful to have knowledge of prior patents, i.e. prior art, in related areas of technology as only one patent may be granted per invention. The process of ascertaining prior art is known as a patent search. The results of the patent search generally help the drafter of any subsequent patent application focus his or her efforts on what appears to be patentable subject matter and aids in developing a reasonable strategy for achieving the goals of the inventor or owner of the patent rights.

Prior to the evolution of technology into the current electronic information age, it was known that patent searches were conducted manually. A searcher would review a patent disclosure and based upon a patent classification system, ascertain where the patent disclosure may be classified, and thereafter conduct a search. With the advent of information technology, paper searching is no longer efficient as all patents and published patent applications are also available in electronic form.

Different classes of searches may be commissioned to achieve different results. For example, a novelty search may be commissioned for ascertaining whether or not to file for a patent. A product clearance search may be commissioned for ascertaining whether a product is could potentially infringe the claims of a current patent. An invalidity search may be commissioned to determine if the issued claims of a patent are valid, etc. Prior electronic search tools do not support the different classes of searches. As the quantity of electronic patents and publications in databases grow by the millions around the world, searching for prior art patents is once again becoming labor-intensive instead of greater efficiency expected with electronic search tools.

There is therefore a need for a method and system that enables searching of subject matter related patent documents more efficiently, thereby, yielding accurate and desirable search results.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages:

FIG. 1 is a block diagram showing an exemplary environment in which various embodiments may function;

FIG. 2 is a flowchart of a computerized method of searching documents, in accordance with an embodiment;

FIG. 3 is a flowchart of performing a search on a document database, in accordance with an embodiment;

FIG. 4 is a flowchart of a method of searching documents, in accordance with another embodiment;

FIG. 5 is a flowchart of a method of searching documents, in accordance with another embodiment;

FIG. 6 is a flowchart of a method of searching documents, in accordance with another embodiment;

FIG. 7 is a flowchart of a method of searching documents, in accordance with another embodiment;

FIG. 8 is a flowchart of a method of automatically conducting a search on a document database to search similar documents, in accordance with an embodiment;

FIG. 9 shows an Adaptive User Interface (AUI) for searching and displaying documents, in accordance with an embodiment; and

FIG. 10 is a block diagram of a system for searching documents, in accordance with an embodiment.

### DETAILED DESCRIPTION

Before describing embodiments in detail, it should be observed that the embodiments reside primarily in combinations of method steps and system components related to methods and systems for searching documents. Accordingly, the system components and method steps have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments provide methods and systems for searching documents. The method includes creating one or more document vectors from one or more input documents. The method further includes performing a search on a document database based on the one or more document vectors to locate one or more output documents related to the one or more input documents. Thereafter, the method includes creating an interactive work-file comprising a list of the one or more output documents and analysis of one or more attributes associated with the one or more output documents.

In an embodiment, the method includes creating one or more document vectors from one or more input documents. The method further includes performing a search on a document database based on the one or more document vectors to locate one or more output documents related to one or more input documents. Thereafter, the method includes creating an interactive work-file for a patent examiner including a list of the one or more output documents and analysis of one or more attributes associated with the one or more output documents, the one or more attributes include one or more of classification codes, assignees listed in the one or more output documents, keywords occurring in the one or more output documents, inventors listed in the one or more output documents, bibliographic information, images, and technology fields associated with one or more output documents.

In another embodiment, the method includes accessing an interactive work-file, wherein the interactive work-file includes a list of one or more output documents, one or more attributes associated with the one or more output documents, and one or more provisions to automatically find similar documents related to one of the one or more output documents. The method further includes performing a predefined operation on one of the one or more provisions in the interactive work-file. Thereafter, the method includes displaying one or more similar document similar to one of the one or more output documents in response to performing the predefined operation.

In an embodiment, users may log into a website and submit technical disclosures. The technical disclosures may be in text, Acrobat (PDF), Microsoft Word or any other commonly used format. After receipt of the technical disclosure one of the search engines are automatically accessed and a search engine is exercised to look for any documents that satisfy the keywords in the received technical disclosure.

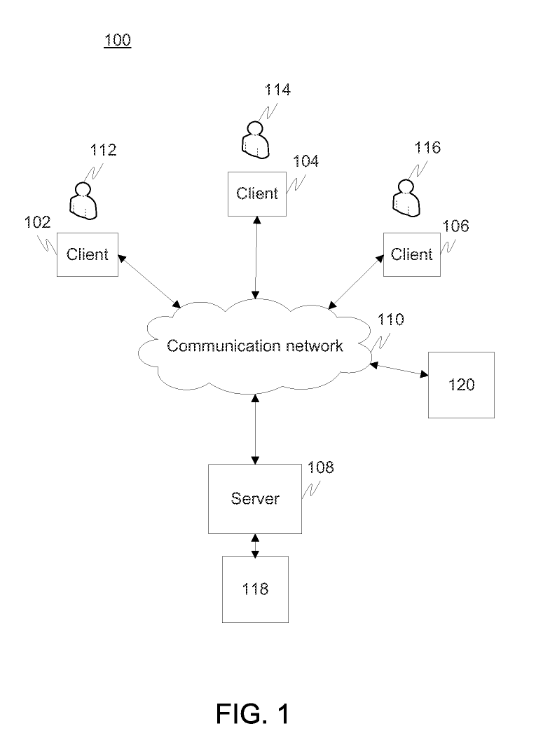

FIG. 1 is a block diagram showing an exemplary network environment 100 in which various embodiments may function. Network environment 100 includes one or more client computing devices, for example, a client 102, a client 104, and a client 106. Examples of the one or more clients may include but are not limited to a computer, a laptop, a Personal Digital Assistant (PDA), and a mobile/smart phone. Each of the one or more clients communicates with a server 108 through a communication network 110. Examples of communication network 110 may include but are not limited to a wired communication network, a wireless communication network, a cellular communication network.

Server 108 includes one or more softwares and one or more databases. The one or more softwares and the one or more databases may be accessed by one or more users (for example, a user 112, a user 114, and a user 116) through the one or more clients. For example, server 108 includes operational patent searching software operationally connected to patent or non-patent document database 118 (“prior art database”). Alternatively, server 108 may access remote patent or non-patent database 120 via communication network 110. User 112 may use a web based User Interface (UI) on client 102 to access the patent searching software on server 108. The patent searching software is used to search and retrieve patent documents from prior art database 118. Patent documents may include, but are not limited to patent applications, granted patents, and prosecution related documents. The result of such a search conducted by user 112 is displayed on client 102.

In an embodiment, the one or more clients may include the one or more softwares and the one or more databases. For example, client 104 includes a patent searching software and server 108 includes a patent document database. In this case, user 114 uses a UI of the patent searching software on client 104 to search and retrieve patent documents from the prior art database 118 or 120.

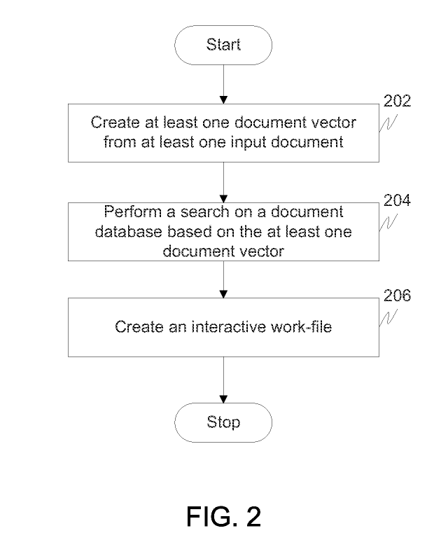

FIG. 2 is a flowchart of a computerized method of searching documents, in accordance with an embodiment. For searching documents, one or more input documents are received from one of the one or more users. The documents may be provided on the one or more clients. An input document may be uploaded through a UI on a client. The input document may be an electronic document, for example, a Microsoft Word™ document, or an Acrobat™ (PDF). The input documents may be a scanned paper document. Each of the input documents may be a legal document. The legal document may further be an intellectual property document. An intellectual property document, for example, may include but is not limited to one of a copyright document, a trademark document, and a patent document. In an embodiment, a user may input an audio file. For example, an audio recording of an invention discussion between an attorney and an inventor be transcribed using voice recognition software and directly used as an input. Therefore, the invention is not limited to a particular form of input.

At step 202, one or more document vectors are created from the one or more input documents. The document vectors may be derived by software installed on server 108 or one of the clients. A document vector is a combination of keywords from an input document and weights that are associated with the keywords. More specifically, a document vector is a document signature that represents content of the document, such that, comparison between different documents is facilitated. A document vector is the numerical representation of unstructured textual content of a document.

A keyword in a document vector may be a word or phrase extracted from the document. In an embodiment, keywords added in a document vector include, but are not limited to noun phrases, words in title case but not at the beginning of a sentence, and words which occur frequently in the document. A weight associated with a keyword is a numerical measure of importance of the keyword for the document. In an embodiment, weights for a keyword may be computed by using one or more of, but not limited to following methods: normalizing the frequency of a keyword in a document from one to zero, where one is assigned to a keyword which occurs most frequently in the document, boosting keywords or keyword-pairs in selected fields of the document, assigning a higher weight to noun phrases, elevating title case keywords in body of a document, and assigning a higher weight to longer strings over shorter strings. In another embodiment, a user may assign a weight to a keyword, according to the user's discretion.

Once keywords for inclusion in a document vector of a document have been selected and weights for the keywords have been computed, the document vector is computed through employment of an integrator. In an embodiment, the integrator may select which fields of a document to include in the document vector and how much to boost the keywords which they include, select how much each of the factors contributes to the final keyword weight, add entity types into the document vector, such as elevating the significance of a corporate entity found in the document, and increasing a stop keyword list to remove common phrases found in the database.

A document vector may be a dynamic document vector. A Dynamic document vector is a document vector that is created at the time of submission of an input document. If the input document is an electronic document, a dynamic document vector is created based on content of the electronic document. Similarly, when an input is a scanned paper document, a dynamic document vector is created based on content of a scanned copy of the paper document using Optical Character Recognition (OCR) technique. The use of document vectors enables efficient and effective processing of an input. This is further helpful in locating relevant documents when a search is performed.

After creating the document vectors, a search is performed on a document database based on the document vectors, at step 204. The document database may be a patent document and/or a technology literature database. In an embodiment, the document database may be a database of a patent office in a particular country. For example, the document database may be United Stated Patent and Trademark Office (USPTO) patent document database that includes all US patent application, US granted patents, and their prosecution history. By way of another example, the document database may be an European Patent Office (EPO) patent document database.

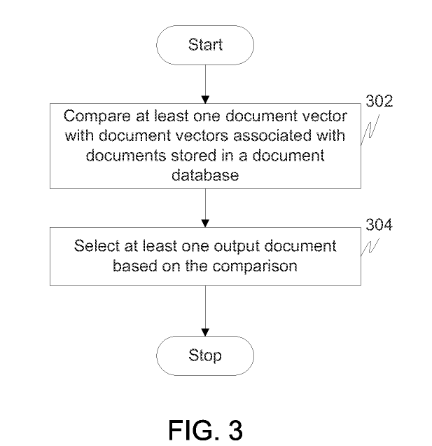

The search may be performed to locate one or more output documents related to the input documents. An output documents may be a patent document, technology literature, and other legal document. The search is performed by comparing the document vectors with document vectors that are associated with documents stored in the document database. The method of performing the search is further explained in detail in conjunction with FIG. 3.

Thereafter, an interactive work-file is created at step 206. The interactive work-file includes a list of the output documents. Each of the output documents may be a legal document. For example, user 114 (e.g., a patent examiner) searches for patent documents related to a particular patent application on client 104. Based on a copy of the patent application provided as an input by user 114 on a web based UI on client 104, a search is performed on a patent document database on server 108. Thereafter, an interactive work-file is generated, which includes a list of patent documents or technology literature that are related to the patent application based on subject matter or family relationship, i.e., Continuation In Part (CIP), divisional, foreign counterpart, or continuation application. Further, the output documents are listed in the report in order of relevancy to the input documents, such that, an output document that is most related to the input documents is listed first in the interactive work-file and an output document that is least related to the inputs is listed last in the interactive work-file. Additionally, each of the output documents may be listed along with a relevancy score. For example, relevancy scores may be percentages depicting the percentage of similarity between an output document and an input document.

In an embodiment, each of the output documents is a search report related to the input documents. When an input document is a patent application, an output document may be a patent search report. The patent search report may be a search report that was generated for patent applications or granted patents that are related to the patent application based on a family relationship or subject matter. For example, when user 114 (a patent examiner) performs a search for prosecuting a US patent application, patent document databases of USPTO and EPO are searched. Based on the search, an interactive work-file is created that includes a patent search report generated for a counterpart EPO patent and a patent search report generated for a US patent from which the patent application claims priority.

The interactive work-file further includes analysis of one or more attributes associated with the one or more output documents. The attributes include one or more of classification codes, assignees listed in the output documents, keywords occurring in the output documents, inventors listed in the output documents, bibliographic information, images, and technology fields associated with the output documents. The analysis of the attributes may include, but are not limited to a bar graph displaying the top assignees along with the number of patents assigned to them, a pie chart for classification codes displaying the classification codes from the search result with the highest number of patents, selected images from the most relevant patent documents in the search.

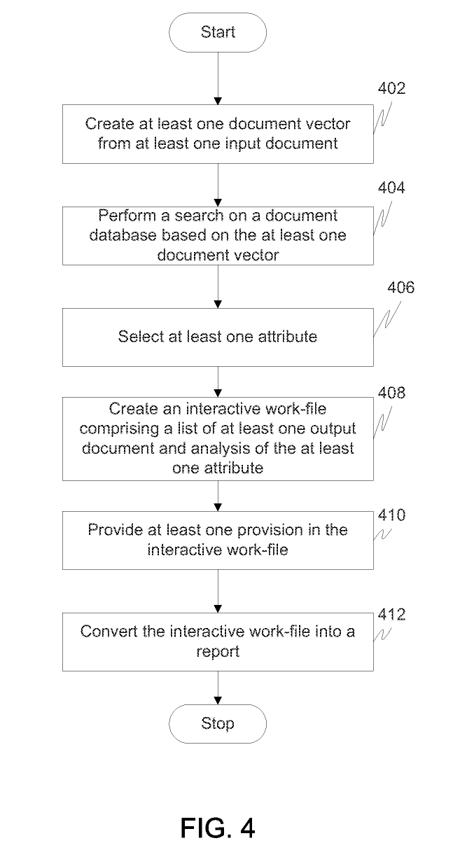

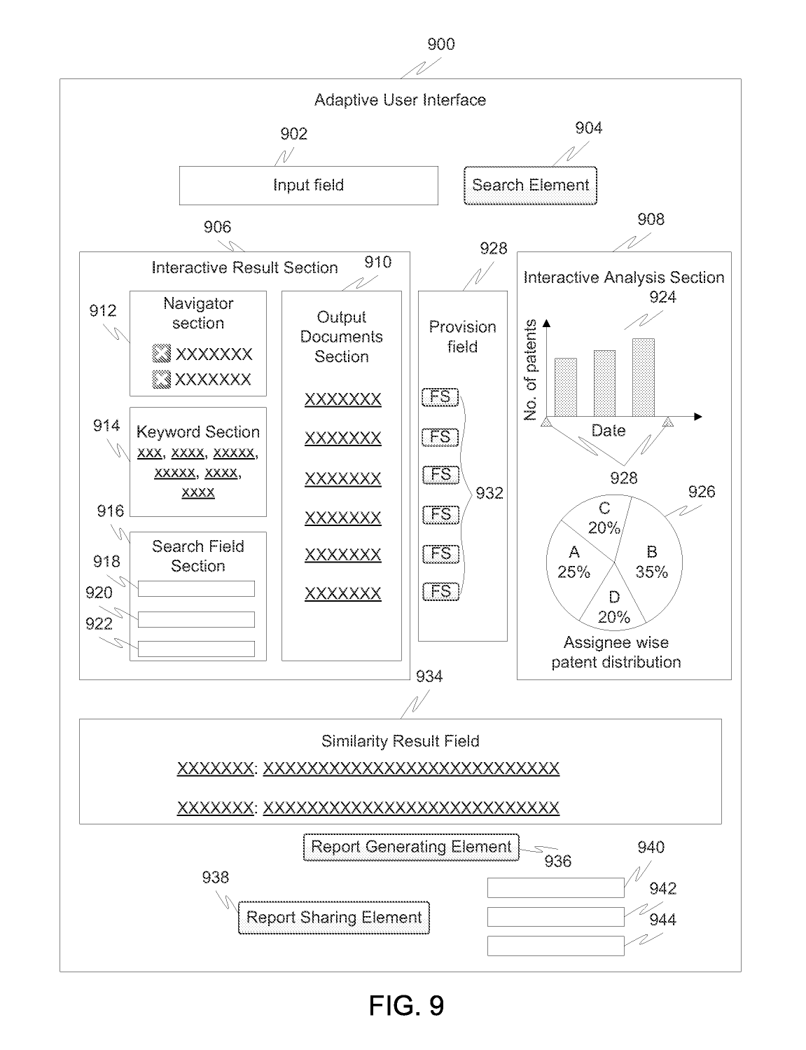

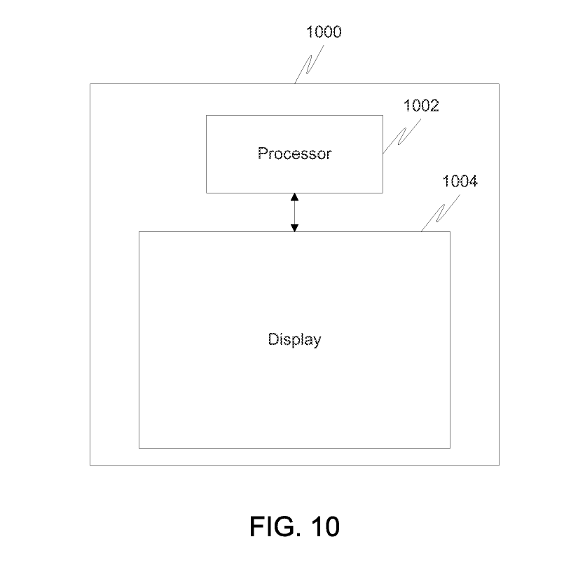

The analysis of the attributes enables a user to obtain a snapshot of the search results. Based on this, a user can easily ascertain key highlights of the search results, for example, top assignees, most relevant companies, top inventors, and mostly cited classification codes. Additionally, based on this analysis, a user can easily determine if his search strategy is correct, thereby, modifying his search strategy to get better results in subsequent iterations. This is further explained in conjunction with FIGS. 9 and 10. In an embodiment, the attributes are selected based on their frequency of occurrence in the output documents. This is further explained in detail in conjunction with FIG. 4.

The interactive work-file further includes one or more elements to modify results of the search that was performed to locate the output documents. The elements include a plurality of subject navigators, a list of suggested keywords, a plurality of search fields. If a user wants to change or narrow down the search results, the user can interact with the elements. This is further explained in detail in conjunction with FIGS. 9 and 10.

FIG. 3 is a flowchart of performing a search on a document database, in accordance with an embodiment. For searching documents, one or more input documents are received from a user. Thereafter, one or more document vectors are created based on the input documents. This has been explained in detail in conjunction with FIG. 2.

At step 302, the document vectors are compared with document vectors associated with documents stored in the document database. The document vectors associated with the documents stored in the document database are static document vectors. Each of the document vectors is one of a dynamic document vector and a static document vector. A static document vector is a document vector that has been already created for a document stored in the document database. The documents stored in the document database are not subject to frequent change, thus a static document vector once formed for a document can be used over a long period of time. For example, the document database is a patent document database. In this case, the patent document database includes granted patents and published patent applications, which are not subject to frequent changes. Thus, static document vectors are created for patent documents stored in the patent document database. Document vectors have been explained in detail in conjunction with FIG. 2.

Thereafter, at step 304, one or more output documents are selected based on the comparison. The output documents are related to the input documents. When document vectors are compared, a mathematical comparison is performed between a dynamic document vector derived from the input documents and the static document vectors associated with the documents stored in the document database. The output documents are sorted based upon the mathematical comparison. In one embodiment, the sorting is hierarchical based upon the closeness of the static document vectors of the documents with the dynamic document vector. A mathematical value is employed to define the range of closeness of documents in the document database to the dynamic document vector. If a static document vector representing a document in the document database falls within the defined mathematical range, the document is selected to be listed as an output document in the report. Accordingly, a comparison of the dynamic document vector with the static document vectors of the documents in the document database enables the selection of the output documents.

As an example of the method of comparison mentioned above, user 112 uploads a patent document as an input document. In the patent document the following words are repeated maximum number of times: load, balancing, communication, and wireless. The patent document is received by a patent searching software and a dynamic document vector is created for the patent document. The dynamic document vector is represented in (1).

[load,1][wireless,0.5][balancing,0.2] (1)

where the numbers are weights assigned to the corresponding keywords.

The dynamic document vector is then compared with static document vectors associated with patent documents stored in a patent document database. The comparison is done by multiplying weights of the keywords in the dynamic document vector with one or more of the static document vectors that also include these keywords. The result of the multiplication is added to derive a similarity ranking.

A static document vector representing a patent document that includes the following keywords: balancing, and wireless, is represented in (2).

[Mobile,1][WAN,0.7][wireless,0.6][balancing,0.5] (1)

The similarity ranking between the dynamic document vector and the static document vector computed by performing the multiplication is represented in (3).

Similarity Ranking=0.5*0.6(wireless)+0.2*0.5(balancing)=0.4 (3)

If the similarity ranking is more than a predefined threshold, the patent document is relevant to user's search criterion and is thus selected as an output document to be displayed in the report.

It will be apparent to a person skilled in the art that other methods not mentioned above may also be used to select the output documents using document vectors.

FIG. 4 is a flowchart of a method of searching documents, in accordance with another embodiment. Based on one or more input documents received from a user, one or more document vectors are created at 402. Thereafter, at 404, a search is performed on a document database using the document vectors to locate one or more output documents related to the input documents. This has been explained in detail in conjunction with FIG. 2.

At 406, one or more attributes associated with the output documents are selected. The attributes are selected based on their frequency of occurrence in the output documents. For example, output documents that are located based on the search are patent documents. In this case, the assignees and the inventors who are most frequently mentioned in the patent documents are selected. Similarly, International Patent Classification (IPC) codes that occur most frequently in the patent documents are selected. Thereafter, at 408 an interactive work-file is created that includes the list of one or more output documents and analysis of the attributes selected at 406. This has been explained in detail in conjunction with FIG. 2.

After creating the interactive work-file, one or more provisions are provided in the interactive work-file at step 410. The provisions include one or more of a radio-button, a link, a checkbox, a toggle-button, a pop-up control, a hover menu, a push button, and a drop-down. The provisions are used to automatically find similar documents related to one of the output documents. When the output documents are patent document, the similar documents may be patent documents that are related to a patent document based on subject matter or family relationship.

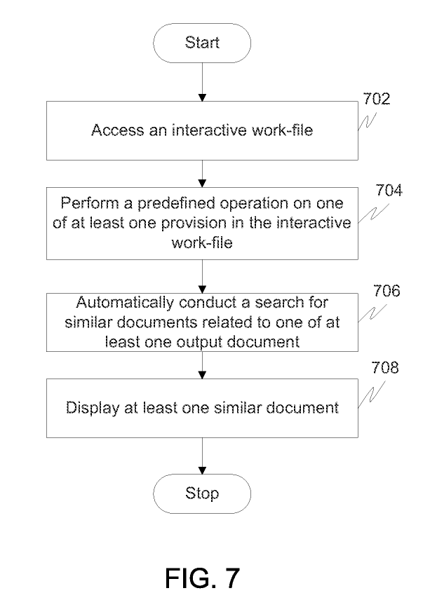

When a provision associated with an output document is activated, similar documents associated with the output document are displayed. This is further explained in detail in conjunction with FIG. 7. As a result of these provisions provided in the interactive work-file, a user is able to considerably reduce the time required for finding relevant documents in a document database. The user first has to identify an interesting document listed in the report and then simply activate a provision, for example, click on a button, associated with the document. Activating the provision locates documents that are similar to the document identified by the user.

The interactive work-file is converted into a report at 412. The report may be one of, but is not limited to patentability analysis report, an invalidity analysis report, and a freedom-to-operate analysis report. In an embodiment, for creating such a report, the input documents may be one of, but not limited to an invention discussion document, a product description document, and a patent infringement document. Thus a user can get a desired type of analysis report based on his requirement using any available document. For example, a user wants to perform a freedom-to-operate analysis for a particular product. The user inputs a product description document, using which a search is performed and a freedom-to-operate analysis report is generated based on the method described above. By way of another example, a user may want to perform a patentability analysis on a particular idea. In this case, the user inputs an invention discussion document, using which a search is performed and a patentability analysis report is generated based on the method described above.

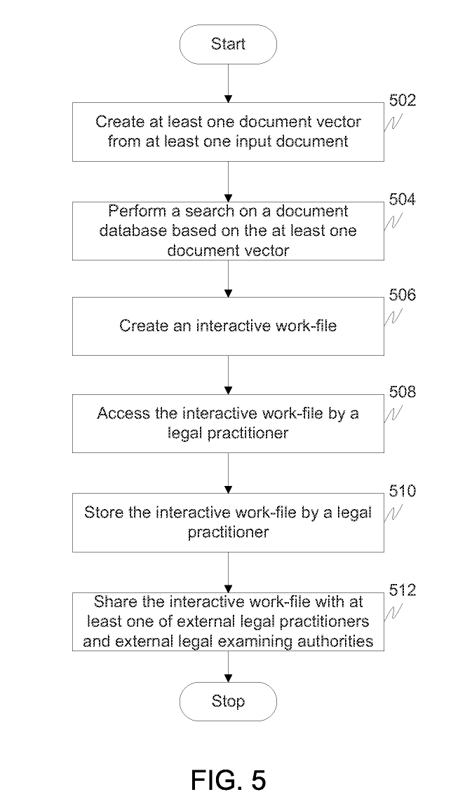

FIG. 5 is a flowchart of a method of searching documents, in accordance with another embodiment. Based on one or more input documents received from a user, one or more document vectors are created at 502. Thereafter, at 504, a search is performed on a document database using the document vectors to locate one or more output documents related to the input documents. At 506, an interactive work-file is created. This has been explained in detail in conjunction with FIG. 2.

In the next step 508, the interactive work-file is accessed by a legal practitioner. Thereafter, the legal practitioner stores the interactive work-file. The interactive work-file may be stored 510 on a local drive of the legal practitioner. At step 512, the interactive work-file is shared by the legal practitioner with external legal practitioners and/or external legal examining authorities. For this, the legal practitioner may share the interactive work-file by sending emails to desired recipients. Alternatively, the legal practitioner may store the interactive work-file on a shared drive and provide access rights to the external legal practitioners and the external legal examining authorities. For example, a USPTO patent examiner is performing a patentability analysis on a patent application and the USPTO patent examiner also wants to get an opinion from an external legal practitioner. Thus, after generating the interactive work-file for the patentability analysis, the USPTO examiner may share the interactive work-file with an external patent lawyer. Alternatively, the USPTO examiner may share the interactive work-file with an EPO examiner who may be prosecuting a family member of the patent application. This would thus be beneficial for EPO examiner.

In an alternative embodiment, while creating the interactive work-file in step 506, the legal practitioner may be automatically provided with an option of sharing the interactive work-file with external legal practitioners and/or external legal examining authorities that would otherwise occur in step 512. For example, the option may be provided by displaying a message box to the legal practitioner displaying the message “Do you want to share the interactive work-file” and a “YES” and “NO” button. When the legal practitioner selects “YES”, he is provided with one or more email address fields for entering email addresses of desired recipients. By way of other example, the display message box may display the message “Save the interactive work-file on a shared-drive” and a “YES” and “NO” button. When the legal practitioner selects the “YES” button, the interactive work-file is saved on the shared-drive and the external legal practitioners and/or external legal examining authorities that have access rights to the shared-drive are sent an email notification regarding the saved interactive work-file. The shared-drive access rights can be set by the legal practitioner to selectively grant access to desired users.

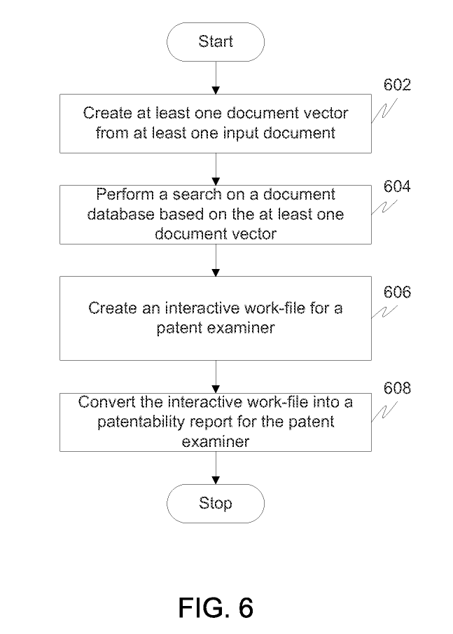

FIG. 6 is a flowchart of a method of searching documents, in accordance with another embodiment. Based on one or more input documents received from a user, one or more document vectors are created at 602. Thereafter, at 604, a search is performed on a document database using the document vectors to locate one or more output documents related to the input documents. At 606, an interactive work-file is created for a patent examiner. The interactive work-file includes a list of the output documents and analysis of one or more attributes associated with the output documents. The attributes include, but are not limited to classification codes, assignees listed in the output documents, keywords occurring in the output documents, inventors listed in the output documents, bibliographic information, images, and technology fields associated with the output documents. This has been explained in detail in conjunction with FIG. 2. Thereafter, at 608, the interactive work-file is converted into a patentability report for the patent examiner.

FIG. 7 is a flowchart of a method of searching documents, in accordance with another embodiment. Based on one or more input documents received from a user, an interactive work-file is created that includes a list of one or more output documents and analysis of one or more attributes associated with the output documents. The attributes include, but are not limited to classification codes, assignees listed in the output documents, keywords occurring in the output documents, inventors listed in the output documents, bibliographic information, images, and technology fields associated with the output documents. This has been explained in detail in conjunction with FIG. 2.

The interactive work-file further includes one or more provisions to automatically find similar documents related to the output documents. The provisions include one or more of a radio-button, a link, a checkbox, a toggle-button, a pop-up control, a hover menu, a push button, and a drop-down. Additionally, one or more provisions in the interactive work-file may include one or more elements to modify contents of the interactive work-file. The elements may include a plurality of subject navigators, a list of suggested keywords, and a plurality of search fields. This is further explained in detail in conjunction with FIGS. 9 and 10.

Referring again to FIG. 7, a user accesses the interactive work-file at step 702. The user may, for example, be a patent examiner in a patent office and the interactive work-file may depict patentability analysis for a patent application. For example, user 112 (a patent examiner) accesses a patent searching software operational on server 108 through a web based UI on client 102 to search patent documents stored in a patent document database on server 108. For this, user 112 accesses the interactive work-file through a web based UI of the patent searching software. The interactive work-file includes a list of patent documents or technology literature. In the interactive work-file, adjacent to each patent document or technology literature, a push button is provided to search similar patent documents or technology literature.

At step 704, the user performs a predefined operation on one of the provisions provided in the interactive work-file. The predefined operation may include, but are not limited to one or more of activating the link, clicking on the radio-button, clicking on the toggle-button, clicking on the pop-up control, hovering mouse cursor over the hover menu, clicking on the drop-down, and clicking on the push button. In response to performing the predefined operation, a search is automatically conducted on a document database to search similar documents related to one of the output documents, at step 706. For example, in the interactive work-file depicting patentability analysis, as discussed in the above example, a push button is provided adjacent to each patent document. User 112 finds that a patent application listed in the patent search report is interesting and clicks on the push button adjacent to the patent application. In response to this, a search is automatically conducted to find similar patent documents or technology literatures that are related to the patent application.

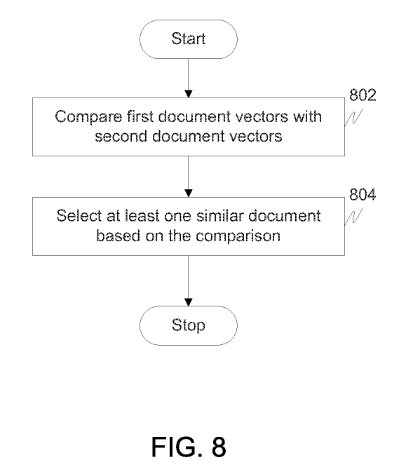

To search similar documents, first document vectors associated with one of the output documents are compared with second document vectors associated with documents stored in the document database. This is further explained in detail in conjunction with FIG. 8.

In response to performing the predefined operation, one or more similar documents related to one of the output documents are displayed at step 708. The similar documents may be ranked in order of relevancy to the one of the output documents. For example, when user 112 clicks on the push button adjacent to the patent application, as discussed in the above example, a search is automatically conducted to find similar patent documents or technology literatures related to the patent application. Based on the search, one or more similar patent documents are displayed on a webpage on client 102. They are displayed, such that, a patent document which is most similar to the patent application is ranked first and a patent document which is least similar to the patent application is ranked last. Alternatively, the similar documents may be listed along with a relevancy score corresponding to the output documents. For example, when each patent document in the list of patent documents is assigned a relevancy score in percentages depicting similarity with an input document, the similar patent documents are also assigned relevancy scores in percentages depicting their respective similarity with the input document.

The one or more similar documents may be displayed on the interactive work-file itself. Alternatively, the similar documents may be displayed on a separate report or a webpage. As a result of these provisions provided in the interactive work-file, a user is able to considerably reduce the time required for finding relevant patent documents. The user has to identify an interesting patent document listed in the report. Then, to find patent documents that are similar to the patent document identified by the user, the user has to simply activate a provision, for example, click on a button. Moreover, as the similar patent documents are displayed in an order of relevancy, therefore, a user does not have to spend time in analyzing each similar document to determine which one is the most relevant.

FIG. 8 is a flowchart of a method of automatically conducting a search on a document database to search similar documents, in accordance with an embodiment. After accessing an interactive work-file that includes one or more output documents, analysis of one or more attributes associated with the output documents, and one or more provisions to find similar documents related to the output documents, user performs a predefined operation on one of the provisions. This has been explained in detail in conjunction with FIG. 7.

In response to performing the predefined operation, at step 802, first document vectors associated with one of the output documents are compared with second document vectors associated with documents stored in a document database. Each of the first document vectors and each of the second document vectors are one of a dynamic document vector and a static document vector. In an embodiment, first document vectors are dynamic document vectors as one of the output documents may not be stored in the document database and the second document vectors are static document vectors, as these document vectors are generated for documents already stored in the document database. In another embodiment, first document vectors also are static document vectors as one of the output documents may be already stored in the document database.

For example, an interactive work-file includes ten patent applications listed as output documents. A push button is displayed adjacent to each of the ten patent applications. A patent examiner after accessing the patent search report finds that a patent application listed on the top is the most interesting. Thus, to find patent documents similar to the patent application, the patent examiner clicks on the push button adjacent to the patent application. In response to this, dynamic document vectors for the patent application are created and are compared with static document vectors of patent documents stored in a patent document database. The process of comparison of document vectors has been explained in detail in conjunction with FIG. 3.

Based on the comparison, one or more similar documents are selected from the document database, at step 804. The similar documents may be selected based on a similarity ranking between document vectors of one of the output documents and documents vectors of documents stored in the document database. The process of selecting one or more document based on comparison of document vectors has been explained in detail in conjunction with FIG. 3. In an embodiment, each of the similar documents are absent in the list of the output documents. As a result, a user does not have to go through same documents repetitively, thereby reducing the time required to find relevant documents.

After a work-file is created as described in the steps of FIG. 6, in an alternative embodiment, a further analysis of a patent application is performed for the purposes of targeting highly relevant prior art to individual claims of a patent application. An Examiner first searches for prior art that is relevant under 35 USC 102 provisions of the United States law that would anticipate each claim of the patent application. If a single prior art reference cannot be located that would anticipate each of the claims, then the Examiner must continue to search for multiple references that could be cited under provisions of 35 USC 103 that would render the applicant's claims obvious. This is a much more difficult task to perform, since judgment calls must be made by the Examiner not only on determining which sections of which references should be applied towards certain phrase elements of the claims but also make judgment calls on whether the multiple references could technically be combined and would have been combined by one skilled in the art at the time of the invention without using hindsight. All of the research and analysis by the Examiner for creating a case for obviousness consumes a considerable amount of time in relation to finding a single reference that would anticipate each claim in the application. Previously, no tools were available for examiners or attorneys to efficiently build a 103 obviousness case without manually reading each reference received from a traditional prior art searches.

The alternative embodiment provides an additional report within the Examiner's work-file for locating and reporting references that could be used to build a 103 obviousness case against the claims cited in the patent application. Referring to the flowchart of FIG. 6, the embodiment matches relevant prior art sections of text to individual and combinations of claims phrases such as “elements” or “clauses,” or “steps” or “method steps”

By using a relevancy score of prior art results for each individual claim element in a claim or independent/dependent claim set, an Examiner can target his or her search very quickly for building a 103 obviousness case. For example, if each element of an independent claim are found to have high relevancy scores all from a single prior art reference, then a 102 rejection could possibly be alleged against the claim. However, if an element from a claim that depends from the independent claim displays a low relevance score in the examiner's work-file for that same reference, then this alerts the examiner that a 103 obviousness case may have to be researched, organized, and asserted against the applicant.

A patent application is input into an application database. Input parameters can either require that claims are submitted as a separate input part, or a smart software system can search the input application and identify the section titled “Claims” since that section is required to be so identified in each application. The claims section is further analyzed for language in each preamble to each claim to determine proper claim sets of independent claims and claims that depend from each independent claim. At 602, each phrase from each claim in each claim set is vectorized with dynamic document vectors. Prior art is then searched for each claim set. From a pre-set top number of resulting references, each phrase of each claim is then searched against the result set of references. A relevance score is assigned to each claim element and displayed next to each element in the examiner's work-file. The prior art reference citation and exemplary text is also displayed next to the scored claim element

FIG. 9 shows an Adaptive User Interface (AUI) 900 for searching and displaying documents, in accordance with an embodiment. AUI 900 includes an input field 902, a search element 904, an interactive result section 906, and an interactive analysis section 908. Input field 902 receives one or more input documents from a user. This has been explained in detail in conjunction with FIG. 2 and FIG. 3. Thereafter, search element 904 is activated to create one or more document vectors from the input documents. Activating search element 904 also performs a search on a document database based on the document vectors to locate one or more output documents related to the input documents. It will be apparent to a person skilled in the art that though search element 904 is depicted as a push button, search element 904 may also be one of, but is not limited to a radio button, and a link. In an embodiment, receiving of the input documents may automatically initiate the process of creation of the document vectors and performing of the search.

The list of the output documents is displayed in an output documents section 910 of interactive result section 906. The output documents may be displayed in order of their relevancy to the input documents. This facilitates a user to easily identify an output document which is the most relevant. Thus the user does not have to spend time in analyzing each output document to determine its relevancy.

The display of the list is modifiable based on inputs that may be received at one or more of a navigator section 912, a keyword section 914, and a search field section 916. Navigator section 912 displays a plurality of navigators. The plurality of navigators includes categories that are interpretive of classification codes, for example, IPC, ECLA, and USPC. Deselecting a navigator removes the search results that come under the category depicted by the navigator. Also, selecting the navigator results in displaying the search results that come under the category depicted by the navigator.

Keyword section 914 displays a list of suggested keywords. The suggested keywords may be synonyms of words that are repeatedly used in the output documents. Additionally, the suggested keywords may be equivalent technical terms for the frequently used technical terms in the output documents. For example, the term “cache memory” is not used in Japan; instead the term “flash memory” is used. Therefore, if output documents displayed in interactive result section 906 repeatedly use the term “cache memory”, the term “flash memory” may displayed in keyword section 914. Selecting a keyword in keyword section 914 results in displaying documents that use the selected keyword and are similar to the output documents.

To further modify the display of the output documents, search field section 916 displays a plurality of search fields (for example, a search filed 918, a search field 920, and a search field 922). Each search field may be associated with a particular field and may be used for narrowing search results. For example, search field 918 may be for entering assignee names, search field 920 may be for entering inventor names, and search field 920 may be for entering classification codes. Therefore, if a user wants to narrow down displayed list of patent documents to a particular assignee, user enters the assignee name in the search field 918. This would result in displaying only those patent documents that belong to the assignee.

In addition to displaying the output documents, analysis of one or more attributes associated with the output documents is displayed on interactive analysis section 908. The attributes have been explained above. Analysis of the attributes enables a user to get a better understanding regarding the user's search strategy. Thus, a user can modify his search strategy to get better results in subsequent iterations. Also, when the output documents are patent documents, the analysis, for example, may be a bar graph 924 displaying the number of patents filed in a particular date range. By way of another example, the analysis may be a pie-chart 926 displaying the percentage of patents documents that belong to a particular assignee out of the patent documents displayed in output documents section 910. Therefore, a user may be able to extract useful information like, top assignees, most active inventors, and filing pattern. It will be apparent to a person skilled in the art that the analysis is not limited to bar graph and a pie-chart and may include similar graphical analysis.

The display of the analysis is modifiable based on received inputs, which may be received through a second plurality of navigators that are displayed along with the analysis. For example, the output documents are patent documents and bar graph analysis 924 for year wise filing of the patent documents is displayed, with the ‘Y’ axis displaying the number of patents and the X axis displaying the date range. Sliding navigators 928 are displayed along with the bar graph analysis on the ‘X’ axis. Thus, a user may slide sliding navigators 928 to modify the year range, such that the user can analyze patents for a desired year range in more detail. A user may also slide sliding navigators 928 such that month or quarter wise filing of patents is displayed in a desired date range. It will be apparent to a person skilled in the art that the second plurality of navigators is not limited to sliding navigators 928.

A user may find one of the output documents interesting and may want to find documents that are similar to one of the output documents. To this end, AUI 900 includes a provision field 930 that displays one or more provisions. The provisions may include a push-button for finding similar documents (for example, Find Similar (FS) push buttons 932). It will be apparent to a person skilled in the art that one or more provisions may also include one or more of a radio-button, a link, a checkbox, a toggle-button, a pop-up control, a hover menu, and a drop-down. Provision field 930 is further configured to receive a predefined operation on one of the one or more provisions. The predefined operation includes one or more of, but is not limited to activating the link, clicking on the radio-button, clicking on the toggle-button, clicking on the pop-up control, hovering mouse cursor over the hover menu, clicking on the drop-down, and clicking on the push button.

In response to the predefined operation, a similarity result field 934 in AUI 900 displays one or more similar documents similar to one of the output documents. This has been explained in detail in conjunction with FIG. 7 and FIG. 8. Similarity result field 934 enables a user to easily find a relevant document. For example, if the input documents and the output documents are patent documents, a user is easily able to find a patent documents that is related by subject matter or family to a patent application received at input field 902. This considerably reduces the time required to conduct a patent analytics project. This is especially beneficial for a patent examiner who is usually time-bound for issuing office actions.

Similarity result field 934 may display the title of each of the similar documents. Additionally, title of each of the similar documents may have a hyperlink, such that, when a user clicks on a title of a similar document, the full text of the similar document is opened in another window (not shown in FIG. 9) of AUI 900.

At any point of time, a user may activate a report generating element 936 to generate a report that includes the information displayed on AUI 900. The user may have an option of removing one or more sections or elements displayed on AUI 900. Thus, the user can retain desired information on AUI 900 and generate a report for that information. The report may include a patentability analysis report, an invalidity analysis report, and a freedom-to-operate analysis report. The report may be generated in multiple formats, for example, MS Word™ format, MS Excel™ format, or PDF™ format.

After generating the report, a user may activate a report sharing element 938 to share the report with external legal practitioners and external legal examining authorities. When the report sharing element 938 is activated, one or more name fields (for example, a name field 940, a name field 942, and a name field 944 may be displayed on AUI 900. The user may enter names of desired legal practitioners or examining authorities in the name fields. Alternatively, the user may enter email addresses. Based on this, the report is shared with the desired personnel for their review and comments. It will be apparent to be a person skilled in the art that one or more of the sections and fields of AUI 900 may be displayed on separate pages in AUI 900.

FIG. 10 is a block diagram of a system 1000 for searching documents, in accordance with an embodiment. System 1000 includes a processor 1002 and a display 1004. In an embodiment, server 108 includes processor 1002 and one of the clients include display 1004. In another embodiment, one of the clients includes processor 1002 and display 1004.

Processor 1002 receives one or more input documents from a user. Thereafter, processor 1002 creates one or more document vectors from the input documents. Each of the input documents may be a scanned paper document. Alternatively, each of the input documents may be an electronic document in a format that includes MS Word, PDF, and MS Excel. Based on the parameters, processor 1002 performs a search on a document database to locate one or more output documents related to the input documents. This has been explained in detail in conjunction with FIG. 2. To perform the search, processor 1002 compares the document vectors with document vectors associated with documents stored in the document database. Based on this comparison, processor 1002 selects the output documents. This has been explained in detail in conjunction with FIG. 3.

Thereafter, processor 1002 creates an interactive work-file that includes a list of the output documents and analysis of one or more attributes associated with the output documents. Processor 1002 also selects the attributes based on frequency of occurrence of the attributes in the output documents. Processor 1002 further provides one or more provisions in the interactive work-file to automatically find similar documents similar to one of the output documents. The interactive work-file is displayed on display 804. This has been explained in detail in conjunction with FIGS. 2, 3, and 4. Based on a user's request, processor 1002 may also share the interactive work-file with one or more external legal practitioners and external legal examining authorities. Processor 1002 is also configured to convert the interactive work-file into a report. If the user is a patent examiner processor 1002 converts the interactive work-file into a patentability report for the patent examiner.

Once the interactive work-file has been generated and displayed, processor 1002 accesses the interactive work-file. Based on a user's input, processor 1002 performs a predefined operation on of the provisions in the interactive work-file. The predefined operation has been explained in detail in conjunction with FIG. 7. Processor 1002 receives the predefined operation and in response automatically conducts a search on the document database to search similar documents related to one of the output documents. To conduct the search, processor 1002 compares first document vectors associated with one of the output documents with second document vectors associated with documents stored in the document database. Each of the first document vectors and each of the second document vectors may be one of a dynamic document vector and a static document vector. Based on the comparison, processor 1002 selects one or more similar documents from the document database. Display 1004 then displays the similar documents. This has been explained in detail in conjunction with FIG. 7 and FIG. 8.

Various embodiments provide methods and systems for searching documents on a patent document database. For searching documents, a user uploads input documents through an AUI. The input documents can be electronic documents or scanned copies of patent applications printed on paper. Thus a user has an ease of using any format of input documents and is not limited to a particular format. Document vectors are created from the input documents and are then used for searching patent documents. The use of document vectors enables efficient and effective processing of an input and is helpful in easily locating relevant patent documents.

The interactive work-file generated after performing the search includes patent documents related to the input documents provided by the user. The patent documents are listed in order of relevancy to the input documents, thus the user does not have to analyze each patent document to determine the most relevant patent document. The interactive work-file also includes analysis of attributes related to the patent documents. The attributes enables a user to get a better understanding regarding the user's search strategy. Thus, the user may modify his search strategy to get better results in a second iteration. The user is also able to extract useful information like, important companies and inventors working in a particular technology field, from the attributes. Additionally, the user can customize the content of the interactive work-file on the fly, thereby getting a desired analysis.

The interactive work-file also includes provisions displayed adjacent to the list of patent documents. As a result of these provisions, a user is able to considerably reduce the time required for finding relevant patent documents. Once the user has identified an interesting patent document listed in the interactive work-file, the user has to simply activate a provision (for example, click on a push button) to find patent documents that are similar to the patent document identified by the user. Moreover, as the similar patent documents are displayed in an order of relevancy, a user does not have to spend time in analyzing each similar patent document to determine which one is most relevant. This is especially beneficial for a patent examiner who is usually time-bound for issuing office actions

Those skilled in the art will realize that the above recognized advantages and other advantages described herein are merely exemplary and are not meant to be a complete rendering of all of the advantages of the various embodiments.

The method of searching documents as described or any of its components may be embodied in the form of a computing device. The computing device can be, for example, but not limited to, a general-purpose computer, a programmed microprocessor, a micro-controller, a peripheral integrated circuit element, and other devices or arrangements of devices, which are capable of implementing the steps that constitute the method.

The computing device executes a set of instructions that are stored in one or more storage elements, in order to process input data. The storage elements may also hold data or other information as desired. The storage element may be in the form of a database or a physical memory element present in the processing machine.

The set of instructions may include various instructions that instruct the computing device to perform specific tasks such as the steps that constitute the method. The set of instructions may be in the form of a program or software. The software may be in various forms such as system software or application software. Further, the software might be in the form of a collection of separate programs, a program module with a larger program or a portion of a program module. The software might also include modular programming in the form of object-oriented programming. The processing of input data by the computing device may be in response to user commands, or in response to results of previous processing or in response to a request made by another computing device.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method of searching documents, comprising:
creating at least one document vector from at least one input document;
performing a search on a document database based on the at least one document vector to locate at least one output document related to the at least one input document; and
creating an interactive work-file comprising a list of the at least one output document and analysis of at least one attribute associated with the at least one output document.

2. The method of claim 1 further comprising providing at least one provision in the interactive work-file to automatically find similar documents similar to one of the at least one output document.

3. The method of claim 2, wherein the at least one provision comprises at least one of a radio-button, a link, a checkbox, a toggle-button, a pop-up control, a hover menu, a push button, and a drop-down.

4. The method of claim 1, wherein the at least one attribute comprises at least one of classification codes, assignees listed in the at least one output document, keywords occurring in the at least one output document, inventors listed in the at least one output document, bibliographic information, images, and technology fields associated with the at least one output document.

5. The method of claim 1, wherein creating the interactive work-file comprises selecting the at least one attribute based on frequency of occurrence of the at least one attribute in the at least one output document.

6. The method of claim 1, wherein performing the search comprises:
comparing the at least one document vector with document vectors associated with documents stored in the document database; and
selecting the at least one output document based on the comparison.

7. The method of claim 6, wherein the document vectors associated with the documents stored in the document database are static document vectors.

8. The method of claim 6, wherein one of the at least one document vector is one of a dynamic document vector and a static document vector.

9. The method of claim 1, wherein the input document is a scanned paper document.

10. The method of claim 1, wherein the input document is an electronic document.

11. The method of claim 1, wherein each of the at least one output document and the input document is a legal document.

12. The method of claim 1, wherein each of the at least one output document is a search report related to the at least one input document.

13. The method of claim 1, wherein the at least one output document is listed in order of relevancy to the at least one input.

14. The method of claim 1 further comprising:
accessing the interactive work-file by a legal practitioner; and
storing the interactive work-file by the legal practitioner.

15. The method of claim 1 further comprising sharing the interactive work-file with at least one of external legal practitioners and external legal examining authorities.

16. The method of claim 1 further comprising converting the interactive work-file into a report.

17. The method of claim 16, wherein the report is one of a patentability analysis report, an invalidity analysis report, and a freedom-to-operate analysis report.

18. The method of claim 17, wherein the at least one input document is one of an invention discussion document, a product description document, and a patent infringement document.

19. The method of claim 1, wherein the interactive work-file further comprises at least one element to modify results of the search performed to locate the at least one output document.

20. The method of claim 19, wherein the each of the at least one element comprises a plurality of subject navigators, a list of suggested keywords, a plurality of search fields.

21. A method of searching documents, comprising:
creating at least one document vector from at least one input document;
performing a search on a document database based on the at least one document vector to locate at least one output document related to the at least one input document; and
creating an interactive work-file for a patent examiner comprising a list of the at least one output document and analysis of at least one attribute associated with the at least one output document, the at least one attribute comprising at least one of classification codes, assignees listed in the at least one output document, keywords occurring in the at least one output document, inventors listed in the at least one output document, bibliographic information, images, and technology fields associated with the at least one output document.

22. The method of claim 21 further comprising converting the interactive work-file into a patentability report for the patent examiner

23. An Adaptive User Interface (AUI) comprising:
an input field configured to receive at least one input document;
a search element, wherein activating the search element creates at least one document vector from the at least one input document and performs a search on a document database based on the at least one document vector to locate at least one output document related to the at least one input document;
an interactive result section configured to display a list of the at least one output document, wherein display of the list is modifiable based on received input; and
an interactive analysis section configured to display analysis of at least one attribute associated with the at least one output document, wherein display of the analysis is modifiable based on received input.

24. The AUI of claim 23, wherein the interactive result section comprises a first plurality of navigators, a list of suggested keywords, a plurality of search fields employable to modify results of the search performed to locate the at least one output document.

25. The AUI of claim 23, wherein the interactive analysis section comprises a second plurality of navigators employable to modify the analysis.

26. The AUI of claim 23, wherein the at least one attribute comprises at least one of classification codes, assignees listed in the at least one output document, keywords occurring in the at least one output document, inventors listed in the at least one output document, and technology fields associated with the at least one output document.

27. The AUI of claim 23 further comprising:
a provision field configured to:
display at least one provision to find similar documents similar to one of the at least one output document; and
receive a predefined operation on one of the at least one provision; and
a similarity result field configured to display at least one similar document similar to one of the at least one output document

28. The AUI of claim 27, wherein the at least one provision comprises at least one of a radio-button, a link, a checkbox, a toggle-button, a pop-up control, a hover menu, a push button, and a drop-down.

29. The AUI of claim 28, wherein the predefined operation comprises at least one of activating the link, clicking on the radio-button, clicking on the toggle-button, clicking on the pop-up control, hovering mouse cursor over the hover menu, clicking on the drop-down, and clicking on the push button.

30. The AUI of claim 25 further comprising a report generating element, activating the report generating element generates a report comprising information displayed on the UI.

31. The AUI of claim 30, wherein the report comprises a patentability analysis report, an invalidity analysis report, and a freedom-to-operate analysis report.

32. A computer program product for searching documents, the computer program product comprising a computer usable medium having a computer readable program code embodied therein, the computer readable program code performing:
creating at least one document vector from at least one input document;
performing a search on a document database based on the at least one document vector to locate at least one output document related to the at least one input document; and
creating an interactive work-file comprising a list of the at least one output document and analysis of at least one attribute associated with the at least one output document.
